(19) United States
(12) Patent Application Publication
(10) Pub. No.: US 2022/0410128 A1
(43) Pub. Date: Dec. 29, 2022

(54) ALUMINA WITH A PARTICULAR PORE PROFILE

(71) Applicant: RHODIA OPERATIONS, Lyon (FR)

(72) Inventors: Julien Hernandez, Antony (FR); Virginie Harle, Senlis (FR); Oguzhan Yaglidere, Cincinnati, OH (US); Andrew D. Allerton, Princeton, NJ (US)

(73) Assignee: RHODIA OPERATIONS, Lyon (FR)

(21) Appl. No.: 17/781,310

(22) PCT Filed: Nov. 25, 2020
(86) PCT No.: PCT/EP2020/083438

§ 371 Date: May 31, 2022

(30) Foreign Application Priority Data
Nov. 29, 2019 (EP) 19315154.5
Nov. 29, 2019 (EP) 19315155.2

(51) Int. Cl. B01J 23/10; B01J 35/10; B01J 35/00; B01J 35/02; B01J 37/04; B01J 37/03; B01J 37/34; B01J 37/02; B01J 37/08; B01J 37/00

(52) U.S. Cl. CPC B01J 23/10; B01J 35/1038; B01J 35/1042; B01J 35/1047; B01J 35/1061; B01J 35/1066; B01J 35/1071; B01J 35/1014; B01J 35/1019; B01J 35/0026; B01J 35/026; B01J 37/04; B01J 37/038; B01J 37/343; B01J 37/0236; B01J 37/08; B01J 37/0063

(57) ABSTRACT

The present invention relates to an alumina with a particular pore profile and good thermal stability. This alumina is also characterized in that it has a high bulk density. The alumina has, after calcining in air at 1100° C. for 5 hours:
a pore volume in the range of pores with a size of between 5 nm and 100 nm which is between 0.50 and 0.75 mL/g, more particularly between 0.50 and 0.70 mL/g; and
a pore volume in the range of pores with a size of between 100 nm and 1000 nm which is less than or equal to 0.20 mL/g, more particularly less than or equal to 0.15 mL/g, or even less than or equal to 0.10 mL/g.

The present patent application claims the priority of European patent applications No. 19315154.5 and No. 19315155.2 both filed on Nov. 29, 2019 and the contents of which are fully incorporated by reference. In case of inconsistency between the text of the present patent application and the text of the French patent application which would affect the clarity of a term or of an expression, reference shall be made solely to the present patent application.

The present invention relates to an alumina with a particular pore profile and good thermal stability. This alumina is also characterized in that it has a high bulk density.

### TECHNICAL FIELD

It is known practice to use an alumina for the preparation of a motor vehicle pollution control catalyst for converting the pollutants emitted by gasoline or diesel thermal engines. Alumina is used as a support for precious metals, notably platinum, palladium and/or rhodium. It may also be combined with other catalyst components, said components depending on the catalyst and on the intended application (diesel or gasoline pollution control). Among the other usual components present in the catalyst, mention may be made of rare-earth metal oxides such as cerium oxides or mixed cerium zirconium oxides used as materials with oxygen mobility for gasoline engine catalysts (three-way catalyst (TWC) or gasoline particle filters (GPF)). Alumina may also be combined with a zeolite used, for example, as a hydrocarbon trap for diesel catalysts or with a zeolite exchanged with copper and/or iron for catalysts for the catalytic reduction of nitrogen oxides with ammonia (SCR) for the reduction of the NOₓ emitted by diesel engines.

### TECHNICAL PROBLEM

For all these motor vehicle pollution control applications, the thermal stability of the alumina is required to be high since this makes it possible to maintain the efficiency of the catalyst over time, i.e. to maintain a good conversion of the gaseous pollutants. The term “thermal stability” means maintaining a high specific surface area after heat treatments at high temperature. A simple and common way of characterizing the thermal stability of an alumina consists in measuring its specific surface area after a heat treatment at high temperature, for example at 1200° C. for 5 hours in air.

The preparation of a motor vehicle pollution control catalyst generally involves the deposition or coating of an alumina-based suspension onto a substrate or monolith. The alumina of the invention is suitable for the preparation of a suspension having a low viscosity, which makes it possible to prepare a suspension having a high proportion of alumina. Moreover, the high density of the alumina of the invention facilitates the handling of the alumina powder.

The thermal stability of aluminas is generally partly linked to the pore volume of the alumina. By increasing this pore volume, the thermal stability is generally increased. This increase in pore volume however brings about a significant lowering of the density of the alumina and an increase in the viscosity of the alumina suspension during the process for preparing the catalyst.

In order to solve this problem, it has been observed that the specific porosity of the alumina of the invention makes it possible to obtain both high thermal stability and a high bulk density.

### TECHNICAL BACKGROUND

U.S. Pat. No. 4,154,812 describes a process for preparing an alumina. This process does not comprise step (e).

### FIGURES

FIG. 1/1 shows a diffractogram of the alumina of the invention (example 1). It may be observed that this alumina has the characteristic peaks of a crystalline alumina.

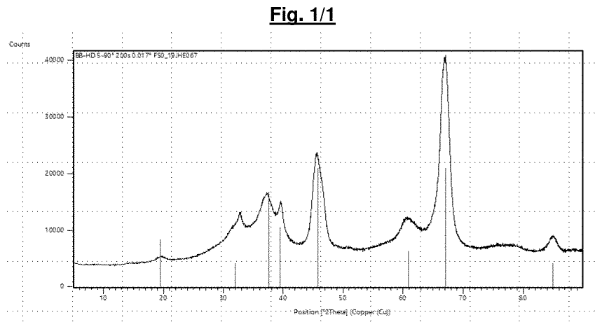

### BRIEF DESCRIPTION OF THE INVENTION

The invention relates to an alumina as defined in one of claims 1 to 42.

Thus, the alumina comprises the elements Al and O and also an additional element (E), which is La, Pr or a combination La+Pr, the proportion of the element (E) possibly being between 0.1% and 6.0% by weight, or even between 0.5% and 6.0% by weight, or else even between 1.0% and 6.0% by weight, or even between 2.0% and 6.0% by weight, this proportion being expressed as weight of the element (E) expressed in the form of oxide relative to the total weight of the alumina,

and it is characterized by at least one of the following two porosity profiles:
first profile:
a pore volume in the range of pores with a size of between 5 nm and 100 nm which is between 0.60 and 0.85 mL/g, more particularly between 0.60 and 0.80 mL/g;

and
a pore volume in the range of pores with a size of between 100 nm and 1000 nm which is less than or equal to 0.20 mL/g, more particularly less than or equal to 0.15 mL/g, or even less than or equal to 0.10 mL/g, or else even less than or equal to 0.05 mL/g;

and/or
second profile: after calcining in air at 1100° C. for 5 hours:
a pore volume in the range of pores with a size of between 5 nm and 100 nm which is between 0.50 and 0.75 mL/g, more particularly between 0.50 and 0.70 mL/g; and
a pore volume in the range of pores with a size of between 100 nm and 1000 nm which is less than or equal to 0.20 mL/g, more particularly less than or equal to 0.15 mL/g, or even less than or equal to 0.10 mL/g, or else even less than or equal to 0.05 mL/g;

these pore volumes being determined by means of the mercury porosimetry technique.

This alumina may comprise sodium and sulfate and also impurities.

The invention also relates to a catalytic composition as defined in claim 43, and also to the use of the alumina as defined in claim 44.

The invention relates to a process for preparing an alumina as defined in one of claims 45 to 52.

All these subjects are now defined in greater detail.

### DESCRIPTION OF THE INVENTION

In the present patent application, it is specified, for the continuation of the description, that, unless otherwise indicated, in the ranges of values which are given, the values at the limits are included. It is also specified that the calcinations are performed in air.

Furthermore, it is specified that the concentrations of the solutions or the proportions in the alumina of the elements Al and element (E) are given as weight percentages of oxide equivalents. The following oxides are thus retained for the calculation of these concentrations or proportions: Al₂O₃ for the element Al, La₂O₃ for the element La and Pr₆O₁₁ for the element Pr. For example, an aqueous aluminum sulfate solution with an aluminum concentration of 2.0% by weight corresponds to a solution containing 2.0% by weight of Al₂O₃ equivalent. Similarly, an alumina comprising 4.0% of lanthanum corresponds to 4.0% of La₂O₃.

The term “particle” means an agglomerate formed from primary particles. The particle size is determined from a particle size distribution by volume obtained by means of a laser particle size analyzer. The particle size distribution is characterized by means of the parameters D10, D50 and D90. These parameters have the usual meaning in the field of measurements by laser diffraction. Dx thus denotes the value which is determined with regard to the particle size distribution by volume for which x % of the particles have a size less than or equal to this value Dx. D50 thus corresponds to the median value of the distribution. D90 corresponds to the size for which 90% of the particles have a size which is less than D90. D10 corresponds to the size for which 10% of the particles have a size which is less than D10. The measurement is generally performed on a dispersion of the particles in water.

The porosity data are obtained via the mercury porosimetry technique. This technique makes it possible to define the pore volume (V) as a function of the pore diameter (D). Use may be made of a Micromeritics Autopore 9520 machine equipped with a powder penetrometer in accordance with the instructions recommended by the manufacturer. The procedure of ASTM D 4284-07 may be followed. By means of these data, it is possible to determine the pore volume in the range of pores whose size is between 5 nm and 100 nm (PV_{5-100 nm}), the pore volume in the range of pores whose size is between 100 nm and 1000 nm (PV_{100-1000 nm}) and the total pore volume (TPV).

The term “specific surface area” means the BET specific surface area determined by nitrogen adsorption determined by means of the Brunauer-Emmett-Teller method. This method was described in the journal “The Journal of the American Chemical Society, 60, 309 (1938)”. The recommendations of the standard ASTM D3663-03 may be followed. Unless otherwise indicated, the calcinations for a given temperature and a given duration correspond to calcinations in air at a steady temperature stage over the duration indicated.

The alumina of the invention is an alumina comprising an additional element (E) which is La, Pr or a combination La+Pr. Thus, the alumina is composed of the elements Al, O and €. The element (E) may notably and advantageously be the element La. This type of alumina comprising such an element is generally described as a doped alumina. The proportion of the element (E) is between 0.1% and 6.0% by weight, or even between 0.5% and 6.0% by weight, this proportion being expressed as weight of the element (E) expressed in the form of oxide relative to the total weight of the alumina. This proportion may be between 1.0% and 6.0% by weight, or even between 2.0% and 6.0% by weight. The element (E) is generally present in the alumina in oxide form.

The alumina of the invention is characterized by a particular porosity. Thus, this alumina has at least one of the following two porosity profiles:

first profile:
a pore volume in the range of pores with a size of between 5 nm and 100 nm which is between 0.60 and 0.85 mL/g, more particularly between 0.60 and 0.80 mL/g; and
a pore volume in the range of pores with a size of between 100 nm and 1000 nm which is less than or equal to 0.20 mL/g, more particularly less than or equal to 0.15 mL/g, or even less than or equal to 0.10 mL/g, or else even less than or equal to 0.05 mL/g;

second profile: after calcining in air at 1100° C. for 5 hours:
a pore volume in the range of pores with a size of between 5 nm and 100 nm which is between 0.50 and 0.75 mL/g, more particularly between 0.50 and 0.70 mL/g; and
a pore volume in the range of pores with a size of between 100 nm and 1000 nm which is less than or equal to 0.20 mL/g, more particularly less than or equal to 0.15 mL/g, or even less than or equal to 0.10 mL/g, or else even less than or equal to 0.05 mL/g;

The alumina may also be defined by at least one of the following two porosity profiles:
first profile:
a pore volume in the range of pores with a size of between 5 nm and 100 nm which is between 0.60 and 0.85 mL/g; and
a pore volume in the range of pores with a size of between 100 nm and 1000 nm which is less than or equal to 0.20 mL/g; and

and/or
second profile: after calcining in air at 1100° C. for 5 hours:
a pore volume in the range of pores with a size of between 5 nm and 100 nm which is between 0.50 and 0.75 mL/g; and
a pore volume in the range of pores with a size of between 100 nm and 1000 nm which is less than or equal to 0.20 mL/g.

The alumina that is described in the present patent application may have at least one of the two abovementioned profiles, it being understood that it may have both profiles simultaneously.

Moreover, the alumina may have a high specific surface area. It may have a BET specific surface area of between 100 and 200 m²/g, more particularly between 150 and 200 m²/g. This specific surface area may be greater than or equal to 120 m²/g, preferably greater than or equal to 140 m²/g. This specific surface may also be between 100 and 140 m²/g, or even between 100 and 120 m²/g.

The alumina moreover has high thermal stability. It may have a BET specific surface area after calcining in air at 1200° C. for 5 hours of between 45 and 60 m²/g.

The alumina generally has a total pore volume which is generally strictly greater than 1.05 mL/g. This total pore volume may advantageously be at least 1.10 mL/g, or even at least 1.20 mL/g, or else even at least 1.30 mL/g or at least 1.40 mL/g or at least 1.50 mL/g. This total pore volume is generally not more than 2.40 mL/g.

The alumina conserves a high total pore volume even after calcining at 1100° C. for 5 hours. Thus, after calcining at 1100° C. for 5 hours, the alumina generally has a total pore volume which is at least 0.90 mL/g. This total pore volume is preferably at least 1.00 mL/g, or even at least 1.10 mL/g, or else even more advantageously at least 1.20 mL/g. This total pore volume is generally not more than 1.80 mL/g.

The alumina may have a bulk density of between 0.25 g/cm³ and 0.55 g/cm³, more particularly between 0.40 g/cm³ and 0.55 g/cm³. This bulk density of the alumina powder corresponds to the weight of a certain amount of powder relative to the volume occupied by this powder:

bulk density in g/mL=(mass of the powder (g))/(volume of the powder (mL))

This bulk density may be determined by the method described below. Firstly, the volume of a measuring cylinder of about 25 mL with no spout is determined precisely. To do this, the empty measuring cylinder is weighed (tare T). Distilled water is then poured into the measuring cylinder up to the rim but without exceeding the rim (no meniscus). The measuring cylinder filled with distilled water is weighed (M). The mass of water contained in the measuring cylinder is thus:

E=M−T

The calibrated volume of the measuring cylinder is equal to V_{measuring cylinder}=E/(density of water at the measurement temperature). The density of the water is, for example, equal to 0.99983 g/mL for a measurement temperature of 20° C.

The alumina powder is carefully poured into the empty and dry measuring cylinder using a funnel until the rim of the cylinder is reached. The excess powder is levelled off using a spatula. The powder must not be compacted or tamped down during the filling. The measuring cylinder containing the powder is then weighed.

bulk density (g/mL)=(mass of the measuring cylinder containing the alumina powder−Tare T (g))/(V_{measuring cylinder} (mL))

The alumina may have a D50 of between 2.0 μm and 80.0 μm. It may have a D90 of less than or equal to 150.0 μm, more particularly less than or equal to 100.0 μm. It may have a D10 of greater than or equal to 1.0 μm.

First Embodiment

According to a first embodiment, the alumina has a D50 of between 2.0 and 15.0 μm, or even between 4.0 and 12.0 μm. The D90 may be between 20.0 μm and 60.0 μm, or even between 25.0 μm and 50.0 μm.

According to the first embodiment, when the D50 is between 2.0 and 15.0 μm,
the bulk density is between 0.25 and 0.40 g/cm³;

and/or
the total pore volume is between 1.40 and 2.40 mL/g.

This total pore volume may advantageously be between 1.50 and 2.40 mL/g.

Second Embodiment

According to a second embodiment, the alumina has a D50 of between 15.0 and 80.0 μm, or even between 20.0 and 60.0 μm. The D90 may be between 40.0 μm and 150.0 μm, or even between 50.0 μm and 100.0 μm.

According to the second embodiment, when the D50 is between 15.0 and 80.0 μm,
the bulk density may be between 0.40 and 0.55 g/cm³;

and/or
the total pore volume is between 1.05 (value excluded) and 1.80 mL/g.

This total pore volume may more advantageously be between 1.20 and 1.80 mL/g.

The alumina may comprise residual sodium. The content of residual sodium may be less than or equal to 0.50% by weight, or even less than or equal to 0.15% by weight. The sodium content may be greater than or equal to 50 ppm. This content may be between 50 and 900 ppm, or even between 100 and 800 ppm. This content is expressed as weight of Na₂O relative to the total weight of the alumina. Thus, for an alumina having a residual sodium content of 0.15%, it is considered that there is, per 100 g of alumina, 0.15 g of Na₂O. The method for determining the sodium content within this concentration range is known to those skilled in the art. Use may be made, for example, of the inductively coupled plasma spectroscopy technique.

The alumina may comprise residual sulfate. The content of residual sulfate may be less than or equal to 1.00% by weight, or even less than or equal to 0.20% by weight, or else even less than or equal to 0.10% by weight. The sulfate content may be greater than or equal to 50 ppm. This content may be between 100 and 1500 ppm, or even between 400 and 1000 ppm. This content is expressed as weight of sulfate relative to the total weight of the alumina. Thus, for an alumina having a residual sulfate content of 0.50%, it is considered that there is, per 100 g of alumina, 0.50 g of SO₄. The method for determining the sulfate content within this concentration range is known to those skilled in the art, for instance the inductively coupled plasma spectroscopy technique. Use may also be made of microanalysis techniques. A microanalysis device of the Horiba EMIA 320-V2 type may be suitable for use.

The alumina may also contain impurities other than sodium and sulfate, for example impurities based on silicon, titanium or iron. The proportion of each impurity is generally less than 0.10% by weight, or even less than 0.05% by weight.

It will also be noted that the alumina is crystalline. This may be demonstrated by means of an X-ray diffractogram. The alumina may comprise a delta phase, a theta phase, a gamma phase or a mixture of at least two of these phases.

Particular Alumina

The alumina of the invention may more particularly have at least one of the following two porosity profiles:

first profile:
a pore volume in the range of pores with a size of between 5 nm and 100 nm which is between 0.60 and 0.85 mL/g, more particularly between 0.60 and 0.80 mL/g; and
a pore volume in the range of pores with a size of between 100 nm and 1000 nm which is less than or equal to 0.05 mL/g;

and/or

second profile: after calcining in air at 1100° C. for 5 hours:
a pore volume in the range of pores with a size of between 5 nm and 100 nm which is between 0.50 and 0.75 mL/g, more particularly between 0.50 and 0.70 mL/g; and
a pore volume in the range of pores with a size of between 100 nm and 1000 nm which is less than or equal to 0.05 mL/g.

As previously, this particular alumina may have at least one of the two abovementioned profiles, it being understood that it may have both profiles simultaneously.

This particular alumina may also have the following features:
a BET specific surface area of between 150 and 200 m²/g; and
a BET specific surface area after calcining in air at 1100° C. for 5 hours of between 70 and 100 m²/g; and
a bulk density of between 0.40 g/cm³ and 0.55 g/cm³; and
a D50 of between 15.0 μm and 80.0 μm; and
a D90 of between 40.0 μm and 150.0 μm.

The sodium and sulfate contents for this particular alumina are as described previously.

Moreover, this particular alumina may also have the total pore volume features as described above. Thus, it generally has a total pore volume which is generally strictly greater than 1.05 mL/g. This total pore volume may advantageously be at least 1.10 mL/g, or even at least 1.20 mL/g, or else even at least 1.30 mL/g or at least 1.40 mL/g or at least 1.50 mL/g. This total pore volume is generally not more than 2.40 mL/g.

This particular alumina conserves a high total pore volume even after calcining at 1100° C. for 5 hours. Thus, after calcining at 1100° C. for 5 hours, the alumina generally has a total pore volume which is at least 0.90 mL/g. This total pore volume is preferably at least 1.00 mL/g, or even at least 1.10 mL/g, or else even more advantageously at least 1.20 mL/g. This total pore volume is generally not more than 1.80 mL/g.

Use of the Alumina

The alumina of the invention may be used in the field of pollution control catalysis for the exhaust gases of gasoline or diesel thermal engines. A catalytic composition comprising the alumina of the invention and at least one oxide based on cerium and optionally on at least one rare-earth metal other than cerium is used in this field. This oxide may be, for example, cerium oxide (generally represented by the formula CeO₂), a mixed oxide based on cerium, zirconium and optionally at least one rare-earth metal other than cerium. The rare-earth metal other than cerium may be chosen from the group formed by yttrium, praseodymium and neodymium.

Preparation Process

The invention also relates to a process for preparing an alumina optionally containing an additional element (E) chosen from lanthanum, praseodymium or a combination of these two elements, notably the alumina as described previously or as described in one of claims 1 to 41, comprising the following steps:

(a) the following are introduced with stirring into a tank initially containing an acidic aqueous solution with a pH of between 0.5 and 4.0, or even between 0.5 and 3.5:
(a1)—either an aqueous solution of sodium aluminate until a pH of the reaction mixture of between 8.0 and 10.0, or even between 8.5 and 9.5, is obtained;
(a2)—or, simultaneously, (i) an aqueous solution of aluminum sulfate and (ii) an aqueous solution of sodium aluminate until a pH of the reaction mixture of between 6.5 and 10.0, or even between 7.0 and 8.0 or between 8.5 and 9.5, is obtained;

so that, at the end of step (a), the aluminum concentration of the reaction mixture is between 0.50% and 3.0% by weight;

(b) followed by simultaneous introduction of an aqueous solution of aluminum sulfate and an aqueous solution of sodium aluminate, the rates of introduction of which are such that the mean pH of the reaction mixture is maintained within the pH range targeted in step (a);

the temperature of the reaction mixture for steps (a) and (b) being at least 60° C.;

(c) on conclusion of step (b), the pH of the reaction mixture is optionally adjusted to a value of between 7.5 and 10.5, or even between 8.0 and 9.0 or between 9.0 and 10.0;

(d) the reaction mixture is then filtered and the solid recovered is washed;

(e) a dispersion in water of the solid recovered on conclusion of step (d) undergoes a mechanical or ultrasonication treatment so as to reduce the particle size of the dispersion;

(f) at least one salt of the element (E) is added to the dispersion obtained on conclusion of step (e);

(g) the dispersion obtained on conclusion of step (f) is dried;

(h) the solid obtained from step (g) is then calcined in air.

Step (a)

In step (a), the following are introduced with stirring into a tank initially containing an acidic aqueous solution with a pH of between 0.5 and 4.0, or even between 0.5 and 3.5:
(a1)—either an aqueous solution of sodium aluminate until a pH of the reaction mixture of between 8.0 and 10.0, or even between 8.5 and 9.5, is obtained;
(a2)—or, simultaneously, (i) an aqueous solution of aluminum sulfate and (ii) an aqueous solution of sodium aluminate until a pH of the reaction mixture of between 6.5 and 10.0, or even between 7.0 and 8.0 or between 8.5 and 9.5, is obtained;

so that, at the end of step (a), the aluminum concentration of the reaction mixture is between 0.50% and 3.0% by weight.

The acidic aqueous solution initially contained in the tank has a pH of between 0.5 and 4.0, or even between 0.5 and 3.5. This solution may consist of a dilute aqueous solution of a mineral acid, for instance sulfuric acid, hydrochloric acid or nitric acid.

The acidic aqueous solution may also consist of an aqueous solution of an acidic aluminum salt such as aluminum nitrate, chloride or sulfate. Preferably, the aluminum concentration of this solution is between 0.01% and 2.0% by weight, or even between 0.01% and 1.0% by weight, or else even between 0.10% and 1.0% by weight. Preferably, the acidic aqueous solution is an aqueous solution of aluminum sulfate. This solution is prepared by dissolving aluminum sulfate in water or by diluting preformed aqueous solution(s) in water. The pH of the aqueous solution developed by the presence of the aluminum sulfate is generally between 0.5 and 4.0, or even between 0.5 and 3.5.

Step (a) is performed according to two embodiments (a1) or (a2). According to embodiment (a1), an aqueous solution of sodium aluminate is introduced with stirring. According to embodiment (a2), (i) an aqueous solution of aluminum sulfate and (ii) an aqueous solution of sodium aluminate are introduced simultaneously with stirring.

Preferably, the aqueous solution of sodium aluminate does not contain any precipitated alumina. The sodium aluminate preferably has an Na₂O/Al₂O₃ ratio of greater than or equal to 1.20, for example between 1.20 and 1.40.

The aqueous solution of sodium aluminate may have an aluminum concentration of between 15.0% and 35.0% by weight, more particularly between 15.0% and 30.0% by weight, or even between 20.0% and 30.0%. The aqueous solution of aluminum sulfate may have an aluminum concentration of between 1.0% and 15.0% by weight, more particularly between 5.0% and 10.0% by weight.

On conclusion of step (a), the aluminum concentration of the reaction mixture is between 0.50% and 3.0% by weight.

In this step (a), the time of introduction of the solution(s) is generally between 2 min and 30 min.

In step (a), the introduction of the aqueous solution of sodium aluminate has the effect of increasing the pH of the reaction mixture.

In particular for embodiment (a1), the aqueous solution of sodium aluminate may be introduced directly into the reaction medium, for example via at least one introduction cannula. In particular for embodiment (a2), the two solutions may be introduced directly into the reaction medium, for example via at least two introduction cannulas. For these two embodiments (a1) and (a2), the solution(s) are preferably introduced into a well-stirred zone of the reactor, for example into a zone close to the stirring rotor, so as to obtain efficient mixing of the solution(s) introduced into the reaction mixture. For embodiment (a2), when the solutions are introduced via at least two introduction cannulas, the points of injection via which the two solutions are introduced into the reaction mixture are distributed so that the solutions become efficiently diluted in said mixture. Thus, for example, two cannulas may be arranged in the tank so that the points of injection of the solutions into the reaction mixture are diametrically opposed.

Step (b)

In step (b), an aqueous solution of aluminum sulfate and an aqueous solution of sodium aluminate are introduced simultaneously, the rates of introduction of which solutions are regulated so as to maintain a mean pH of the reaction mixture within the pH range targeted in step (a). Thus, the target value of the mean pH is between:
8.0 and 10.0, or even between 8.5 and 9.5, for the case where embodiment (a1) was followed in step (a); or
6.5 and 10.0, or even between 7.0 and 8.0 or between 8.5 and 9.5, for the case where embodiment (a2) was followed in step (a).

The term “mean pH” means the arithmetic mean of the pH values of the reaction mixture which are recorded continuously during step (b).

Preferably, the aqueous solution of sodium aluminate is introduced at the same time as the aqueous solution of aluminum sulfate at a flow rate that is regulated so that the mean pH of the reaction mixture is equal to the target value. The flow rate of the aqueous solution of sodium aluminate which serves to regulate the pH may fluctuate in the course of step (b).

The time of introduction of the two solutions may be between 10 minutes and 2 hours, or even between 30 minutes and 90 minutes. The flow rate of introduction of the solution or of the two solutions may be constant.

It is necessary for the temperature of the reaction mixture for steps (a) and (b) to be at least 60° C. This temperature may be between 60° C. and 95° C. To do this, the solution initially contained in the tank in step (a) may have been preheated before the start of introduction of the solution(s). The solutions that are introduced into the tank in steps (a) and (b) may also be preheated beforehand.

Step (c)

In step (c), the pH of the reaction mixture is optionally adjusted to a value of between 7.5 and 10.5, or even between 8.0 and 9.0 or between 9.0 and 10.0, by adding a basic or acidic aqueous solution.

The acidic aqueous solution that may be used for adjusting the pH may consist of an aqueous solution of a mineral acid, for instance sulfuric acid, hydrochloric acid or nitric acid. The acidic aqueous solution may also consist of an aqueous solution of an acidic aluminum salt such as aluminum nitrate, chloride or sulfate.

The basic aqueous solution that may be used for adjusting the pH may consist of an aqueous solution of a mineral base, for instance sodium hydroxide, potassium hydroxide or aqueous ammonia. The basic aqueous solution may also consist of an aqueous solution of a basic aluminum salt such as sodium aluminate. An aqueous solution of sodium aluminate is preferably used.

Preferably, the pH is adjusted by stopping:

(c1)—the introduction of the aqueous sulfate solution and the introduction of the aqueous solution of sodium aluminate is continued until the target pH is reached; or alternatively

(c2)—the introduction of the aqueous solution of sodium aluminate and the introduction of the aqueous solution of aluminum sulfate is continued until the target pH is reached.

According to one embodiment, the introduction of the aqueous solution of aluminum sulfate is stopped and the introduction of the aqueous solution of sodium aluminate is continued until a target pH of between 8.0 and 10.5 and preferably between 9.0 and 10.0 is reached. The duration of step (c) may be variable. This duration may be between 5 min and 30 min.

Step (d)

In step (d), the reaction mixture is filtered. The reaction mixture is generally in the form of a slurry. The solid recovered on the filter may be washed with water. To do this, use may be made of hot water having a temperature of at least 50° C.

Step (e)

In step (e), a dispersion in water of the solid recovered on conclusion of step (d) undergoes a mechanical or ultrasonication treatment so as to reduce the particle size of the dispersion. The pH of this dispersion before milling may optionally be adjusted to between 5.0 and 8.0. A nitric acid solution may be used, for example, to do this.

The D50 of the particles of the dispersion before the mechanical or ultrasonication treatment is generally between 10.0 μm and 40.0 μm, or even between 10.0 μm and 30.0 μm. The D50 of the particles of the solid after the mechanical or ultrasonication treatment is preferably between 1.0 μm and 15.0 μm, or even between 2.0 μm and 10.0 μm.

The mechanical treatment consists in applying a mechanical stress or shear forces to the dispersion so as to fractionate the particles. The mechanical treatment may be performed, for example, by means of a ball mill, a high-pressure homogenizer or a milling system comprising a rotor and a stator. On a laboratory scale, use may be made of a Microcer or Labstar Zeta ball mill, both of which are sold by the company Netzsch (for further details, see: https://www.netzsch-grinding.com/fr/produits-solutions/broyage-humide/broyeurs-de-laboratoire-serie-mini/). A milling system as described in the examples may be used. In the case of a ball mill, use may be made, for example, of yttrium-stabilized zirconium oxide beads. ZetaBeads Plus 0.2 mm balls may be used, for example.

The ultrasonication treatment consists, for its part, in applying a sound wave to the dispersion. The sound wave which propagates through the liquid medium induces cavitation which enables the particles to be fractionated. On a laboratory scale, use may be made of an ultrasonication system with a Sonics Vibracell VC750 generator equipped with a 13 mm probe. The duration and the power applied are adjusted so as to achieve the targeted D50.

The mechanical or ultrasonication treatment may be performed in batch mode or continuously.

Step (f)

In step (f), at least one salt of the element (E) is added. It may also be envisaged to add in this step an aqueous ammonia solution to raise the pH, preferably to a value of between 5.0 and 8.0.

Step (q)

In step (g), the dispersion from step (f) is dried, preferably by spraying.

Spray-drying has the advantage of giving particles with a controlled particle size distribution. This drying method also offers good production efficiency. It consists in spraying the dispersion as a mist of droplets in a stream of hot gas (for example a stream of hot air) circulating in a chamber. The quality of the spraying controls the size distribution of the droplets and, consequently, the size distribution of the dried particles. The spraying may be performed using any sprayer known per se. Two main types of spraying devices exist: turbines and nozzles. Regarding the various spraying techniques that may be implemented in the present process, reference may be made notably to the standard manual by Masters entitled “Spray-Drying” (second edition, 1976, published by George Godwin, London). The operating parameters which a person skilled in the art can modify are notably the following: the flow rate and the temperature of the dispersion entering the sprayer; the flow rate, pressure, humidity and temperature of the hot gas. The inlet temperature of the gas is generally between 100° C. and 800° C. The outlet temperature of the gas is generally between 80° C. and 150° C.

The D50 of the powder recovered on conclusion of step (g) is generally between 2.0 μm and 80.0 μm. This size is linked to the size distribution of the droplets leaving the sprayer. The evaporation capacity of the atomizer is generally linked to the size of the chamber. Thus, on a laboratory scale (Büchi B 290), the D50 may be between 2.0 and 15.0 μm. On a larger scale, the D50 may be between 15.0 and 80.0 μm.

Step (h)

In step (h), the solid obtained from step (g) is calcined in air. The calcination temperature is generally between 500° C. and 1000° C., more particularly between 800° C. and 1000° C. The calcination time is generally between 1 and 10 hours. The calcination conditions given in the examples may be used.

It may be envisaged to perform the two steps (g) and (h) in the same equipment in which the dispersion obtained from step (f) undergoes a heat treatment for performing both drying and calcination.

Preferably, the alumina that is recovered on conclusion of step (h) (i.e. on conclusion of the calcination) has a D50 generally between 2.0 μm and 80.0 μm. It generally has a D90 of less than or equal to 150.0 μm, more particularly less than or equal to 100.0 μm.

According to a first embodiment, on conclusion of step (h), the D50 may be between 2.0 and 15.0 μm, or even between 4.0 and 12.0 μm. The D90 may be between 20.0 μm and 60.0 μm, or even between 25.0 μm and 50.0 μm. This embodiment may rather be performed when step (f) is performed on a laboratory scale using, for example, a Büchi B 290 atomizer.

According to a second embodiment, on conclusion of step (h), the D50 may be between 15.0 and 80.0 μm, or even between 20.0 and 60.0 μm. The D90 may be between 40.0 μm and 150.0 μm, or even between 50.0 μm and 100.0 μm. This embodiment may rather be performed when step (f) is performed on a larger scale.

The process may also comprise a final step via which the solid obtained in the preceding step undergoes milling so as to adjust the particle size of the solid. Use may be made of a knife mill, an air jet mill, a hammer mill or a ball mill. Preferably, the milled product has a D50 generally between 2.0 μm and 15.0 μm. The D90 may be between 20.0 μm and 60.0 μm, or even between 25.0 μm and 50.0 μm.

The alumina of the invention is in the form of a powder.

Further details for the preparation of the alumina of the invention will be found in the following illustrative examples.

### EXAMPLES

Measurement of the Specific Surface Area:

For the continuation of the description, the term “specific surface area” means the BET specific surface area determined by nitrogen adsorption in accordance with the standard ASTM D 3663-03 established from the Brunauer-Emmett-Teller method described in the journal “The Journal of the American Chemical Society, 60, 309 (1938)”. The specific surface area is determined automatically using, for example, a Tristar II 3020 machine from Micromeritics in accordance with the instructions recommended by the manufacturer. The samples are pretreated at 250° C. for 90 min under vacuum (for example to reach a pressure of 50 mmHg). This treatment makes it possible to remove the physisorbed volatile species at the surface (for instance H₂O, etc.).

Measurement of the Porosity with Mercury

The measurement is performed using a mercury porosimetry machine. In the present case, use was made of a Micromeritics Autopore IV 9520 machine equipped with a powder penetrometer, in accordance with the instructions recommended by the manufacturer. The following parameters were used: penetrometer used: 3.2 ml (Micromeritics reference: penetrometer type No. 8); capillary volume: 0.412 ml; max. pressure (“head pressure”): 4.68 psi; contact angle: 130°; surface tension of the mercury: 485 dynes/cm; density of the mercury: 13.5335 g/ml. At the start of the measurement, a vacuum of 50 mmHg is applied to the sample for 5 min. The equilibrium times are as follows: low pressure range (1.3-30 psi): 20 s-high pressure range (30-60 000 psi): 20 s. Prior to the measurement, the samples are treated at 200° C. for 120 min to remove the physisorbed volatile species at the surface (for instance H₂O, etc.).

From this measurement, the pore volumes may be deduced.

Measurement of the Particle Size (D10, D50, D90)

To perform the particle size measurements, use is made of a Malvern Mastersizer 2000 or 3000 laser diffraction particle size analyzer (further details regarding this machine are given here: https://www.malvernpanalytical.com/fr/products/product-range/mastersizer-range/mastersizer-3000). The laser diffraction technique used consists in measuring the intensity of the light scattered during the passage of a laser beam through a sample of dispersed particles. The laser beam passes through the sample and the intensity of the scattered light is measured as a function of the angle. The diffracted intensities are then analyzed to calculate the particle size using the Mie scattering theory. The measurement makes it possible to obtain a volume-based size distribution, from which the parameters D10, D50 and D90 are deduced.

### Example 1: Preparation of an Aluminum Oxide According to the Invention Containing 4% Lanthanum (96% Al₂O₃-4% La₂O₃) According to Embodiment (a1)

3200 g of deionized water are placed in a tank stirred by means of an inclined-blade stirring rotor, and equipped with a pH probe located in the upper part of the liquid, and the water is heated to 75° C. This temperature is maintained throughout steps (a) to (c). 285 g of an aluminum sulfate solution with a concentration of 8.3% by weight of alumina (Al₂O₃) are introduced at a flow rate of 19 g/min via an introduction cannula close to the stirring rotor. On conclusion of the introduction, the pH of the feedstock is close to 1.5 and the aluminum concentration is 0.7% by weight. The introduction of the aluminum sulfate solution is then stopped.

step (a): a sodium aluminate solution with a concentration of 24.9% by weight of alumina (Al₂O₃) and an Na₂O/Al₂O₃ mole ratio of 1.27 is introduced at a flow rate of 14 g of solution/min via a second introduction cannula close to the stirring rotor, until a pH of 9.0 is reached. The introduction is then stopped. The aluminum concentration of the reaction mixture is then 2.10%.

In step (b), the introduction of the aluminum sulfate solution is again started at a flow rate of 12 g of solution/min and the sodium aluminate solution is simultaneously introduced into the stirred reactor at a regulated flow rate so as to maintain the pH at a value of 9.0. This step lasts 45 minutes.

In step (c), the introduction of the aluminum sulfate solution is stopped and the addition of the sodium aluminate solution is continued at a flow rate of 5 g of solution/min until a pH of 9.5 is reached. The addition of the sodium aluminate solution is then stopped.

In step (d), the reaction slurry is poured onto a vacuum filter. On conclusion of the filtration, the cake is washed with deionized water at 60° C.

In step (e), the cake is redispersed in deionized water to obtain a dispersion with a concentration in the region of 11% by weight of oxide (Al₂O₃). A nitric acid solution at a concentration of 69% by weight is added to the suspension so as to obtain a pH close to 6.2. The suspension is passed through a Labstar Zeta brand ball mill from the manufacturer Netzsch. The operating conditions of the mill are adjusted so as to obtain a D50 of 4.2 microns.

In step (f), an aqueous solution of lanthanum acetate is prepared at a concentration in the region of 8% by weight of oxide (La₂O₃) This solution is added with stirring to the suspension obtained from step (e) so as to obtain an La₂O₃/(La₂O₃+Al₂O₃) mass ratio of 4.0%.

In step (g), the suspension obtained from step (f) is atomized to obtain a dry lanthanum-doped aluminum hydrate powder.

In step (h), the atomized powder is calcined at 900° C. for 2 hours (temperature increase rate of 4° C./min). The loss of mass observed during this calcination is 26.1%.

### Example 2: Preparation of an Aluminum Oxide According to the Invention Containing 2% Lanthanum (98% Al₂O₃-2% La₂O₃) According to Embodiment (a1)

157 kg of deionized water are introduced into the same stirred reactor and heated to 85° C. This temperature is maintained throughout steps (a) to (c). 13.8 kg of an aluminum sulfate solution with a concentration of 8.3% by weight of alumina (Al₂O₃) are introduced at a flow rate of 920 g of solution/min via an introduction cannula close to the stirring rotor. On conclusion of the introduction, the pH of the feedstock is close to 2.6 and the aluminum concentration is 0.7% by weight. The introduction of the aluminum sulfate solution is then stopped.

step (a): a sodium aluminate solution with a concentration of 24.9% by weight of alumina (Al₂O₃) and an Na₂O/Al₂O₃ mole ratio of 1.27 is introduced at a flow rate of 690 g of solution/min via a second introduction cannula close to the stirring rotor, until a pH of 9.0 is reached. The introduction is then stopped. The aluminum concentration of the reaction mixture is then 2.10%.

In step (b), the introduction of the aluminum sulfate solution is again started at a flow rate of 570 g of solution/min and the sodium aluminate solution is simultaneously introduced into the stirred reactor at a regulated flow rate so as to maintain the pH at a value of 9.0. This step lasts 45 minutes.

In step (c), the introduction of the aluminum sulfate solution is stopped and the addition of the sodium aluminate solution is continued at a flow rate of 320 g of solution/min until a pH of 9.5 is reached. The addition of the sodium aluminate solution is stopped.

In step (d), the reaction slurry is poured onto a vacuum filter. On conclusion of the filtration, the cake is washed with deionized water at 65° C.

In step (e), the cake is redispersed in deionized water to obtain a suspension having a concentration in the region of 10% by weight of oxide (Al₂O₃). A nitric acid solution at a concentration of 69% by weight is added to the suspension so as to obtain a pH close to 6. The suspension is passed through an LME20 brand ball mill from the manufacturer Netzsch. The operating conditions of the mill are adjusted so as to obtain a D50 of 3.5 microns.

In step (f), a lanthanum acetate solution is prepared at a concentration in the region of 6.9% by weight of oxide (La₂O₃). This solution is added with stirring to the suspension obtained from step (e) so as to obtain an La₂O₃/(La₂O₃+Al₂O₃) mass ratio of 2%.

In step (g), the suspension obtained from step (f) is atomized to obtain a dry lanthanum-doped aluminum hydrate powder.

In step (h), the atomized powder is calcined at 940° C. for 2 hours (temperature increase rate of 3° C./min). The loss of mass observed during this calcination is 25.8%.

### Example 3: Preparation of an Aluminum Oxide According to the Invention Containing 4% Lanthanum (96% Al₂O₃-4% La₂O₃)

Steps (a) to (e) of example 2 are repeated. In step (f), a lanthanum acetate solution is prepared at a concentration in the region of 6.9% by weight of oxide (La₂O₃). This solution is added with stirring to the suspension obtained from step (e) so as to obtain an La₂O₃/(La₂O₃+Al₂O₃) mass ratio of 4%. An aqueous ammonia solution at 10.0% by weight is then added so as to obtain a pH of 8.7.

In step (g), the suspension obtained from step (f) is atomized to obtain a dry lanthanum-doped aluminum hydrate powder.

In step (h), the atomized powder is calcined at 940° C. for 2 hours (temperature increase rate of 3° C./min). The loss of mass observed during this calcination is 26.9%.

### Example 4: Preparation of an Aluminum Oxide According to the Invention Containing 4% Lanthanum (96% Al₂O₃-4% La₂O₃) According to Embodiment (a2)

120 kg of deionized water are introduced into the same stirred reactor and heated to 67° C. This temperature is maintained throughout steps (a) to (c). 1.85 kg of an aluminum sulfate solution with a concentration of 8.3% by weight of alumina (Al₂O₃) are introduced at a flow rate of 370 g of solution/min via an introduction cannula close to the stirring rotor. On conclusion of the introduction, the pH of the feedstock is close to 3.0 and the concentration expressed as oxide equivalent is 0.13% by weight.

step (a): the flow rate of the aluminum sulfate solution is increased to 1020 g of solution/min, and a sodium aluminate solution with a concentration of 24.9% by weight of alumina (Al₂O₃) and an Na₂O/Al₂O₃ mole ratio of 1.27 is introduced simultaneously, via a second introduction cannula close to the stirring rotor, at a flow rate of 1020 g of solution/min, until a pH of 7.3 is reached. The aluminum concentration of the reaction mixture is then 1.40%.

In step (b), the introduction of the aluminum sulfate solution is maintained at a flow rate of 1020 g of solution/min and the sodium aluminate solution is simultaneously introduced into the stirred reactor at a regulated flow rate so as to maintain the pH at a value of 7.3. This step lasts 45 minutes.

In step (c), the introduction of the aluminum sulfate solution is stopped and the addition of the sodium aluminate solution is continued at a flow rate of 1020 g of solution/min until a pH of 10.3 is reached. The addition of the sodium aluminate solution is stopped.

In step (d), the reaction slurry is poured onto a vacuum filter. On conclusion of the filtration, the cake is washed with deionized water at 65° C.

In step (e), the cake is redispersed in deionized water to obtain a suspension having a concentration in the region of 13% by weight of oxide (Al₂O₃). A nitric acid solution at a concentration of 69% by weight is added to the suspension so as to obtain a pH close to 6.2. The suspension is passed through an LME20 brand ball mill from the manufacturer Netzsch. The operating conditions of the mill are adjusted so as to obtain a D50 of 13.4 microns.

In step (f), a lanthanum acetate solution is prepared at a concentration in the region of 6.9% by weight of oxide (La₂O₃). This solution is added with stirring to the suspension obtained from step (e) so as to obtain an La₂O₃/(La₂O₃+Al₂O₃) mass ratio of 4.0%.

In step (g), the suspension obtained from step (f) is atomized to obtain a dry lanthanum-doped aluminum hydrate powder.

In step (h), the atomized powder is calcined at 1035° C. for 2 hours (temperature increase rate of 3° C./min). The loss of mass observed during this calcination is 33%.

### Example 5: Preparation of an Aluminum Oxide According to the Invention Containing 4% Lanthanum (96% Al₂O₃-4% La₂O₃)

Steps (a) to (d) of example 1 are repeated.

In step (e), the cake from step (d) is redispersed in deionized water to obtain a dispersion with a concentration in the region of 11% by weight of oxide (Al₂O₃). A nitric acid solution at a concentration of 69% by weight is added to the suspension so as to obtain a pH close to 6.2. 250 g of this suspension are taken up and treated with an ultrasonication probe. The following equipment is used: ultrasonication system with a 750 W Sonics Vibracell VC750 generator equipped with a 13 mm probe (interchangeable tip) (converter: CV334+13 mm probe tip (Part No. 630-0220). The ultrasonication treatment lasts for 320 seconds. The energy delivered, as read on the generator, is 33 000 joules. The final temperature of the suspension is 56° C. The suspension is left to cool. On conclusion of this treatment, the D50 of the suspension is 6.2 microns.

In step (f), a lanthanum acetate solution is prepared at a concentration in the region of 8% by weight of oxide (La₂O₃). This solution is added with stirring to the suspension obtained from step (e) so as to obtain an La₂O₃/(La₂O₃+Al₂O₃) mass ratio of 4.0%.

In step (g), the suspension obtained from step (f) is atomized to obtain a dry lanthanum-doped aluminum hydrate powder.

In step (h), the atomized powder is calcined at 900° C. for 2 hours (temperature increase rate of 4° C./min). The loss of mass observed during this calcination is 26.3%.

### Example 6: Preparation of an Aluminum Oxide According to the Invention Containing 4% Lanthanum (96% Al₂O₃-4% La₂O₃)

Steps (a) to (d) of example 1 are repeated.

In step (e), the cake is redispersed in deionized water to obtain a dispersion with a concentration in the region of 11% by weight of oxide (Al₂O₃). A nitric acid solution at a concentration of 69% by weight is added to the suspension so as to obtain a pH close to 6.2. 250 g of this suspension are taken up and placed in a Microcer brand ball mill from the manufacturer Netzsch. The operating conditions of the mill are adjusted so as to obtain a D50 of 3.3 microns.

In step (f), a lanthanum acetate solution is prepared at a concentration in the region of 8% by weight of oxide (La₂O₃). This solution is added with stirring to the suspension obtained from step (e) so as to obtain an La₂O₃/(La₂O₃+Al₂O₃) mass ratio of 4.0%.

In step (g), the suspension obtained from step (f) is atomized to obtain a dry lanthanum-doped aluminum hydrate powder.

In step (h), the atomized powder is calcined at 900° C. for 2 hours (temperature increase rate of 4° C./min). The loss of mass observed during this calcination is 27.4%.

TABLE 1

| | | | | BET | | | |
|---|---|---|---|---|---|---|---|
| | Al₂O₃ | La₂O₃ | BET | 1200° C.-5 h | PV₅₋₁₀₀ | PV₁₀₀₋₁₀₀₀ | TPV |
| Ex. | (%) | (%) | (m²/g) | (m²/g) | (mL/g) | (mL/g) | (mL/g) |
| 1 | 96 | 4 | 186 | 59 | 0.74 | 0.09 | 1.60 |
| 2 | 98 | 2 | 149 | 55 | 0.62 | 0.02 | 1.29 |
| 3 | 96 | 4 | 161 | 56 | 0.62 | 0.01 | 1.13 |
| 4 | 96 | 4 | 112 | 45 | 0.61 | 0.02 | 1.07 |
| 5 | 96 | 4 | 180 | 57 | 0.75 | 0.19 | 2.22 |
| 6 | 96 | 4 | 176 | 55 | 0.65 | 0.16 | 1.57 |

TABLE II

| | Bulk | | | | | |
|---|---|---|---|---|---|---|
| | density | D10 | D50 | D90 | Na₂O | SO₄ |
| Ex. | (g/cm³) | (μm) | (μm) | (μm) | (ppm) | (ppm) |
| 1 | 0.33 | 2.2 | 6.3 | 19 | 480 | 990 |
| 2 | 0.44 | 1.4 | 13.0 | 32 | 170 | 620 |
| 3 | 0.50 | 2.7 | 21.0 | 56 | 310 | 690 |
| 4 | 0.55 | 2.3 | 22.0 | 105 | 240 | 630 |
| 5 | 0.26 | 2.8 | 6.6 | 18 | 520 | 1100 |
| 6 | 0.31 | 2.5 | 6.1 | 14 | 470 | 1050 |

1. An alumina comprising an additional element (E), which is La, Pr or a combination La+Pr, the proportion of the element (E) possibly being between 0.1% and 6.0% by weight, this proportion being expressed as weight of the element (E) expressed in the form of oxide relative to the total weight of alumina, characterized by at least one of the following two porosity profiles:
first profile:
a pore volume in the range of pores with a size of between 5 nm and 100 nm which is between 0.60 and 0.85 mL/g; and
a pore volume in the range of pores with a size of between 100 nm and 1000 nm which is less than or equal to 0.20 mL/g;
and/or
second profile: after calcining in air at 1100° C. for 5 hours:
a pore volume in the range of pores with a size of between 5 nm and 100 nm which is between 0.50 and 0.75 mL/g; and
a pore volume in the range of pores with a size of between 100 nm and 1000 nm which is less than or equal to 0.20 mL/g;
these pore volumes being determined by means of the mercury porosimetry technique.

2. (canceled)

3. (canceled)

4. (canceled)

5. (canceled)

6. (canceled)

7. (canceled)

8. The alumina as claimed in claim 1, having a BET specific surface area of between 100 and 200 m²/g.

9. (canceled)

10. (canceled)

11. The alumina as claimed in claim 1, having a BET specific surface area after calcining in air at 1200° C. for 5 hours of between 45 and 60 m²/g.

12. The alumina as claimed in claim 1, having a bulk density of between 0.25 g/cm³ and 0.55 g/cm³.

13. The alumina as claimed in claim 1, having a total pore volume which is strictly greater than 1.05 mL/g, this pore volume being determined using the mercury porosimetry technique.

14. (canceled)

15. (canceled)

16. (canceled)

17. The alumina as claimed in claim 1, having, after calcining at 1100° C. for 5 hours, a total pore volume which is at least 0.90 mL/g, this pore volume being determined using the mercury porosimetry technique.

18. (canceled)

19. (canceled)

20. (canceled)

21. The alumina as claimed in claim 1, characterized, for the first profile, by a pore volume in the range of pores with a size of between 100 nm and 1000 nm which is less than or equal to 0.05 mL/g.

22. The alumina as claimed in claim 1, characterized, for the second profile, by a pore volume in the range of pores with a size of between 100 nm and 1000 nm which is less than or equal to 0.05 mL/g, this pore volume being determined after calcining in air at 1100° C. for 5 hours.

23. (canceled)

24. (canceled)

25. The alumina as claimed in claim 1, characterized by a D50 of between 15.0 and 80.0 μm.

26. The alumina as claimed in claim 25, characterized by a D90 of between 40.0 μm and 150.0 μm, D90 denoting the size for which 90% of the particles have a size which is less than D90, of a particle size distribution by volume obtained by means of a laser particle size analyzer.

27. The alumina as claimed in claim 25, characterized by a bulk density of between 0.40 and 0.55 g/cm³.

28. (canceled)

29. (canceled)

30. (canceled)

31. (canceled)

32. (canceled)

33. (canceled)

34. (canceled)

35. The alumina as claimed in claim 1, having a sodium content of less than or equal to 0.50% by weight, this sodium content being expressed as weight of Na₂O relative to the total weight of the alumina.

36. (canceled)

37. (canceled)

38. The alumina as claimed in claim 1, having a sulfate content of less than or equal to 1.00% by weight, or even less than or equal to 0.20% by weight, or else even less than or equal to 0.10% by weight, this sulfate content being expressed as weight of SO₄ relative to the total weight of the alumina.

39. (canceled)

40. (canceled)

41. (canceled)

42. The alumina as claimed in claim 1, having the first and the second porosity profile.

43. A catalytic composition comprising the alumina as claimed in claim 1 and at least one oxide based on cerium and optionally on at least one rare-earth metal other than cerium.

44. (canceled)

45. A process for preparing an alumina containing an additional element (E) chosen from lanthanum, praseodymium or a combination of these two elements, notably an alumina as described in claim 1, comprising the following steps:
(a) the following are introduced with stirring into a tank initially containing an acidic aqueous solution with a pH of between 0.5 and 4.0:
(a1)- either an aqueous solution of sodium aluminate until a pH of the reaction mixture of between 8.0 and 10.0 is obtained;
(a2)- or, simultaneously, (i) an aqueous solution of aluminum sulfate and (ii) an aqueous solution of sodium aluminate until a pH of the reaction mixture of between 6.5 and 10.0 is obtained;
so that, at the end of step (a), the aluminum concentration of the reaction mixture is between 0.50% and 3.0% by weight;
(b) followed by simultaneous introduction of an aqueous solution of aluminum sulfate and an aqueous solution of sodium aluminate, the rates of introduction of which are such that the mean pH of the reaction mixture is maintained within the pH range targeted in step (a);
the temperature of the reaction mixture for steps (a) and (b) being at least 60° C.;
(c) on conclusion of step (b), the pH of the reaction mixture is optionally adjusted to a value of between 7.5 and 10.5;
(d) the reaction mixture is then filtered and the solid recovered is washed;
(e) a dispersion in water of the solid recovered on conclusion of step (d) undergoes a mechanical or ultrasonication treatment so as to reduce the particle size of the dispersion;
(f) at least one salt of the element (E) is added to the dispersion obtained on conclusion of step (e);
(g) the dispersion obtained on conclusion of step (f) is dried;
(h) the solid obtained from step (g) is then calcined in air.

46. (canceled)

47. The process as claimed in claim 45, in which, for embodiment (a1), the aqueous solution of sodium aluminate is introduced directly into the reaction mixture, via at least one introduction cannula.

48. The process as claimed in claim 45, in which, for embodiment (a2), the two solutions are introduced directly into the reaction mixture, via at least two introduction cannulas.

49. The process as claimed in claim 45, in which the target value targeted in step (b) is between:
8.0 and 10.0 for the case where embodiment (a1) was followed in step (a); or
6.5 and 8.5 for the case where embodiment (a2) was followed in step (a).

50. (canceled)

51. (canceled)

52. The process as claimed in claim 45, in which the mechanical treatment in step (e) is performed by means of a ball mill, a high-pressure homogenizer or a milling system comprising a rotor and a stator.
